(19) United States
(12) Patent Application Publication
(10) Pub. No.: US 2007/0196811 A1
(43) Pub. Date: Aug. 23, 2007

(54) Use Of Flavanol Derivatives For The Cryopreservation Of Living Cells

(76) Inventors: Josep Lluis Torres Simon, Barcelona (ES); Juan Jesus Alvarez Gonzalez, La Corina (ES); Carles Lozano Perez, Barcelona (ES)

Correspondence Address: BERENBAUM, WEINSHIENK & EASON, P.C, 370 17TH STREET, SUITE 4800, DENVER, CO, 80202, US

(21) Appl. No.: 11/573,542

(22) PCT Filed: Aug. 4, 2005
(86) PCT No.: PCT/EP05/53837

§ 371 Date: Feb. 9, 2007

(30) Foreign Application Priority Data
Aug. 10, 2004 (EP) 04381028.2

(51) Int. Cl. A01N 1/02

(52) U.S. Cl. 435/1.3; 435/2

(57) ABSTRACT

A medium for storing a biological sample, in particular sperm, oocytes, embryos and stem cells, in a refrigerated, frozen or vitrified state. The medium includes a balanced salt solution, a cryoprotectant, and a 4-thioderivative of flavan-3-ol of formula (I) with cryoprotective effect

The present disclosure relates to a medium for storing biological samples in a refrigerated, frozen or vitrified state, using flavanol derivatives.

### BACKGROUND

The storage of frozen human and animal cells is of paramount importance in many fields.

For instance if the cells are frozen sperm or embryos, storage is important in assisted human reproduction and it is also important in healing strategies based on the use of stem cells.

The first successful case of cryopreservation of live cells involved spermatozoa. The first human pregnancy with sperm which had been stored in frozen form was accomplished in 1953, when the technique of cryopreservation of human spermatozoa was introduced. In 1963 a method for freezing human semen in liquid nitrogen vapor and its storage at −196° C. was reported. The method allowed the preservation of semen in clinical cryobanks and its use in successful pregnancies resulting in normal births throughout the world. For reviews on the history and current practice of semen cryopreservation see (Anger, Gilbert et al. (2003) J. Urol. 170(4): 1079-1084).

The cellular damage during cryopreservation of human spermatozoa results mainly in a marked decrease in cell motility. Thus, the study of sperm mobility is considered a suitable model for monitoring the performance of cell cryopreservation techniques.

The causes of cellular damage during cryopreservation include the formation of intracellular ice, osmotic changes, bacterial contamination, and oxidative stress. Different substances have been added to the freezing medium in order to avoid such problems. Solutions used for sperm preservation have become standardized and are commercially available. These solutions include the so-called cryoprotectants such as glycerol, propanediol, dimethylsulfoxide, or egg yolk, among others, to avoid the formation of damaging water microcrystals and to minimize the osmotic stress by lowering the salt concentration and by increasing the amount of unfrozen water.

Other substances added to the cryopreservative solutions include energy sources to avoid consumption of intracellular materials; antibiotics to avoid bacterial infections, and salts and buffers to optimize osmotic pressure. A typical cryopreservation solution includes a cryoprotectant (e.g. glycerol), energetic sugar (glucose), salts (sodium, magnesium, potassium as their chlorides or sulphates), a metal chelator (EDTA), a pH regulator (buffer, e.g. HEPES), an albumin (e.g. human serum albumin), and an antibiotic.

Recently, oxidative stress and the subsequent production of reactive oxygen species (ROS) has been recognized as another important cause of cell damage, particularly sperm loss of motility and viability. During the process of freezing/thawing, spermatozoa, as well as other kinds of cells, suffer cold shock which increases their susceptibility to lipid peroxidation, maybe through depletion of endogenous protecting enzymes such as SOD (superoxide dismutase). This has a negative impact in aging, shortening the cell life span and effecting the preservation of healthy cells. Some of the components of standard cryopreservation solutions, such as the metal chelator and albumin, may exert some antioxidant effects.

Nevertheless, the addition of natural or synthetic antioxidants to the freezing solution does not appear to improve sperm motility by more than a few percentage points (Askari, H. A., J. H. Check et al. (1994) Archives of Andrology 33(1): 11-15; Park, N. C., H. J. Park et al. (2003) Asian Journal of Andrology 5(3): 195-201; Roca, J., A. Gil Maria, et al. (2004) Journal of Andrology 25(3): 397-405).

The antioxidants, which include Vitamins E and C, and butylated hydroxytoluene, among others, are able to scavenge free radicals and may inhibit lipid peroxidation to some extent but fail to preserve cell viability and motility accordingly. In fact, other works suggest that membrane stress during the freezing operation is the main cause of reduced cell motility (Alvarez, J. G. and B. T. Storey. Journal of Andrology 14(3): 199-209; Lasso J L, E. E. Noiles et al. Journal of Andrology 15(3): 255-65.

Whatever the reason might be, despite many advances in cryopreservation methodology, both in freezing techniques and additives (cryoprotectants, antioxidants) a dramatic decrease in cell motility always occurs after thawing. Typically, only around 50% of spermatozoa are mobile upon thawing after being kept frozen for 24 h.

The catechins, also known as flavan-3-ols, belong to a family of compounds called flavonoids. Flavonoids are characterised by a structure with two phenolic rings linked by another cyclic carbon structure with one oxygen (pyran). Said flavonoids exist in nature in a free (monomeric) form and in a conjugated form with other flavonoids, sugars and non-flavonoids compounds. The structure of natural flavanols and epicatechin is shown in FIG. 1 herein.

WO02/051829 describes cysteamine derivatives of flavan-3-ols. WO03/024951 describes another cystein derivatives of flavan-3-ols. One of the described derivatives is shown as structure 2 in FIG. 1 herein. Both patents describe the derivatives as having antioxidant effects. Nothing is mentioned about any cryoprotective effect of the thioamine derivatives.

WO97/14785 describes a cryoprotective medium for sperm cells, of a specific defined class of polysaccharides. On page 26 it is said that the medium may include other cryoprotective agents such as glycerol etc. and adjunct agents, such as antioxidants, (e.g. vitamin E), flavonoids and others.

### SUMMARY

The present disclosure describes an improved medium for storing a biological sample in a refrigerated, frozen or vitrified state, wherein cells are less damaged during storage.

The possible cryoprotective effect of a natural flavanol ((−)-epicatechin) were investigated. As with other tested antioxidant compounds (e.g. Vitamins E and C), it was found that natural flavanol has no significant storage stabilizing cryoprotective effect.

Despite this, the cryoprotective effect of different thioamine derivatives of flavan-3-ols of general formula (I) was also tested. It was found that a medium of these thioamine derivatives of flavan-3-ols could be used to significantly reduce the cell damage of frozen stored cells. See, e.g., working example 7 herein which illustrates this for frozen sperm cells.

Accordingly, a first aspect described herein relates to a medium for storing a biological sample in a refrigerated, frozen, or vitrified state, comprising a balanced salt solution, a cryoprotectant, and a 4-thioderivative of flavan-3-ol of formula (I) with cryoprotective effect:

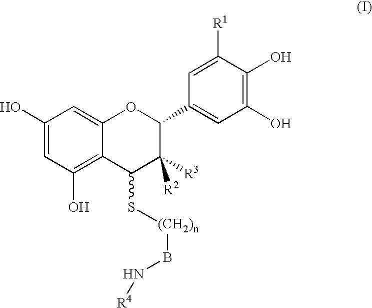

wherein:

R¹ and R² are H or OH, independently of each other, the same or different;

R³ is different from R², and is H, OH or a group of formula:

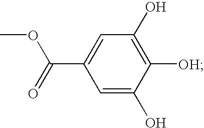

B is a single bond or

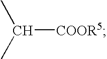

n is 1-6;

R⁴ is H, —C(O)—R⁶, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;

R⁵ is H, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;

R⁶ is linear or branched C₁-C₄ alkyl;

or a salt thereof, at a concentration sufficient to reduce cellular damage after storage in a refrigerated, frozen or vitrified state.

A second aspect relates to a method for reducing cellular damage to a biological sample resulting from storage of said sample in a refrigerated, frozen or vitrified state. This method includes:

(a) creating a medium for storing a biological sample in a refrigerated, frozen or vitrified state, by combining a balanced salt solution and a 4-thioderivative of flavan-3-ol of formula (I) with cryoprotective effect:

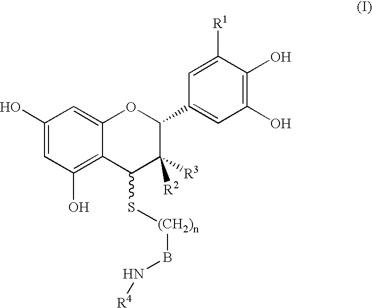

wherein:

R¹ and R² are H or OH, independently of each other, the same or different;

R³ is different from R², and is H, OH or a group of formula:

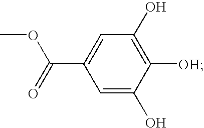

B is single bond or

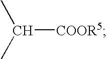

n is 1-6;

R⁴ is H, —C(O)—R⁶, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;

R⁵ is H, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;

R⁶ is linear or branched C₁-C₄ alkyl;

or a salt thereof, at a concentration sufficient to reduce cellular damage after storage in a refrigerated, frozen or vitrified state,

and a biological sample, wherein the derivative of flavan-3-ol is in an amount effective to reduce damage; and

(b) storing the sample in a refrigerated, frozen or vitrified state.

An advantage of using the derivatives of flavan-3-ol (besides their very good cryoprotective stabilizing effect) is that the compounds are known to be non-toxic. Flavan-3-ols may be found in numerous edible products, and human and animals have eaten them for years without any health problems.

### BRIEF DESCRIPTION OF THE DRAWINGS

FIG. 1 shows the depolymerization of proanthocyanidins (polymeric flavan-3-ols). Proanthocyanidins comprise both procyanidins (proanthocyanidins in which R¹ is H) and prodelphinidins (proanthocyanidins in which R¹ is OH). The arrows indicate putative polymerization positions.

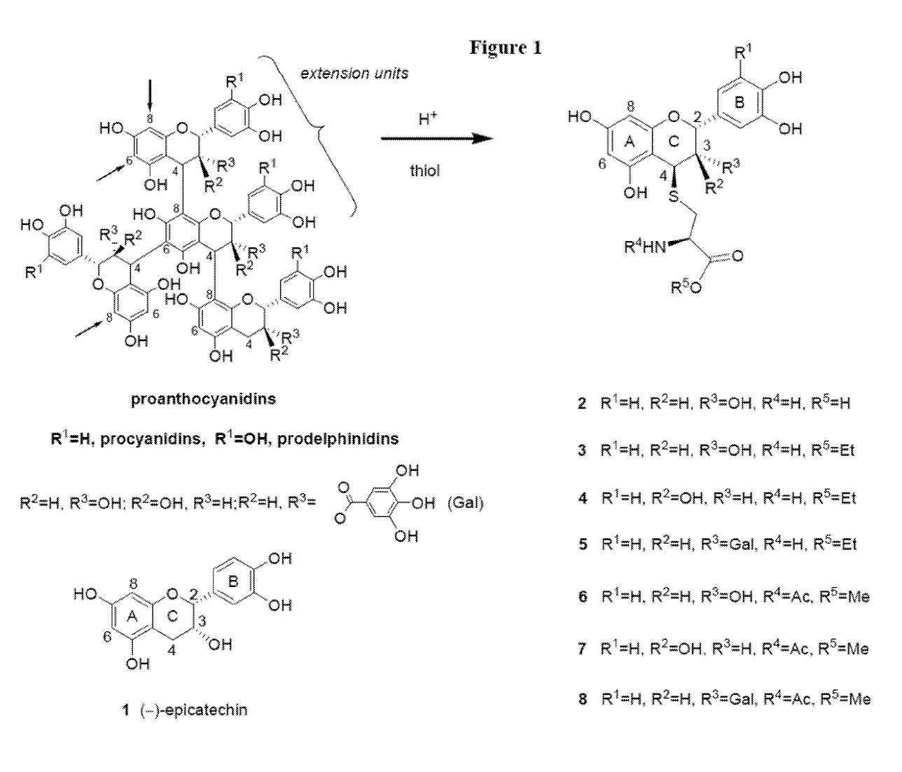

It shows also the 4-thio-derivatives 2, 3, 4, 5, 6, 7, and 8, which correspond to the compound of the example of the patent application WO 03024951, and to compounds of examples 1, 2, 3, 4, 5 and 6 of the present invention, respectively.

### DETAILED DESCRIPTION

Biological Sample

A biological sample, as used herein, may include cells, tissues or organs of human or animal origin, as well as microorganisms and plant embryos.

Human cells and animal cells as used herein may include human, mammalian, avian or piscian cells. Mammalian cells as used herein may include, but are not limited to, cells obtained from bovine, canine, equine, porcine, ovine or rodent species.

Human cells and animal cells as used herein may include, but are not limited to, sperm, oocytes, embryos and stem cells, but also blood cells, such as red blood cells, CNS cells or hepatocytes.

As used herein, human tissues or animal tissues may include blood, bone, cartilage, heart valves, bone marrow, blood vessels, skin, corneas or islets of langerhans.

As used herein, human organs or animal organs may include heart, liver or kidney.

Cells may be selected from the group consisting of sperm, oocyte, embryo and stem cells. In many instances, cells may be selected from the group consisting of sperm and embryo.

As used herein, “embryo” refers to an animal in early stages of growth following fertilization up to the blastocyst stage. An embryo is characterized by having totipotent cells, which are nondifferentiated. In contrast, somatic cells of an individual are cells of a body that are differentiated and are not totipotent.

As used herein “stem cell” refers to a population of cells having identical genetic material. Each cell is totipotent and, if fused with a nonfertilized oocyte, generates genetically identical animals.

Refrigerated, Frozen or Vitrified State

As used herein, the terms refrigerated, frozen and vitrified state may mean states achieved by three modes of low temperature preservation: refrigeration (or hypothermic preservation), freezing preservation and vitrification.

Refrigeration is generally an appropriate means for short-term storage, while freezing or vitrification are generally appropriate means for long or short-term storage.

In hypothermic preservation, biological samples may be maintained at a temperature above freezing. Hypothermic preservation is mostly used for the preservation of whole organs, but is also recommended for the short term transportation of cells.

Freezing preservation and vitrification are known as cryopreservation, and may be used for long or short-term storage of cells.

Vitrification (Rall W F, Fahy G M.; Nature 1985, 313, 573-575) is a cryopreservation method that requires complete suppression of ice formation. It is based on a fast freezing in a mixture of cryoprotectants at high concentrations, which at low temperatures increase their viscosity forming a glass, without ice formation.

Medium for Storing the Biological Sample

The medium for storing the biological sample may contain a 4-thioderivative of flavan-3-ol of formula (I), and a balanced salt solution e.g. a standard balanced salt solution.

The medium for storing the biological sample in a refrigerated state may further contain nonelectrolytes (sucrose, raffinose, saccharoids), citrate and magnesium chelates or high molecular weight anions (lactobionates) used to prevent intracellular edema. Buffers (phosphate, histidine, citrate), manitol or glutathione and glutamate may be included to address the issues of acidosis, free radical production and contracture, respectively. After preservation, the cells may be washed with solutions that have high energy substrates added for energy regeneration and compounds that reduce apoptosis.

The medium for storing the biological sample in a refrigerated state may be a standard solution for storing biological samples in a refrigerated state supplemented with a compound of formula (I). Standard solutions for storing biological samples in a refrigerated state include: University of Wisconsin solution (UW), Bretschneider solution (HTK), Stanford solution (STF), and Euro-Collins solution (EC). Solutions that are based on the extracellular composition include: Celsior solution, St. Thomas Hospital solutions 1 and 2 (STH-1, STH-2), the modified University of Wisconsin solution (UW-1). These solutions have slightly different known indications.

Standard balanced salt media may include, but are not limited to, Tyrode's albumin lactate phosphate (TALP), Earle's buffered salts, Biggers, Whitten and Whitingham (BWW), CZB, T6, Earle's MTF, KSOM, SOF media. Formulas for these media are well known, and preformulated media may be obtained commercially (e.g., Gibco Co. or Fertility Technologies, Natick, Mass.). In addition, a zwitterionic buffer (e.g., MOPS, PIPES, HEPES) may be added.

The medium may be used for storing samples of sperm in a refrigerated state. Thus, the medium may be a standard solution for storing sperm in a refrigerated state, supplemented with a compound of formula (I).

The medium may further contain a cryoprotectant, for storing the sample in a frozen or vitrified state. Such cryoprotectants may include permeating and nonpermeating compounds. Most commonly, DMSO, glycerol, propylene glycol, ethylene glycol, or the like are used. Other permeating agents may include propanediol, dimethylformamide and acetamide. Nonpermeating agents may include polyvinyl alcohol, polyvinyl pyrrolidine, anti-freeze fish or plant proteins, carboxymethylcellulose, serum albumin, hydroxyethyl starch, Ficoll, dextran, gelatin, albumin, egg yolk, milk products, lipid vesicles, or lecithin. Adjunct compounds that may be added include sugar alcohols, simple sugars (e.g., sucrose, raffinose, trehalose, galactose, and lactose), glycosaminoglycans (e.g., heparin, chrondroitin sulfate), butylated hydroxy toluene, detergents, free-radical scavengers, and anti-oxidants (e.g., vitamin E, taurine), amino acids (e.g., glycine, glutamic acid). Glycerol is preferred for sperm freezing, and ethylene glycol or DMSO for oocytes, embryos or stem cells. Typically, glycerol is added at about 3 to about 15%; other suitable concentrations may be readily determined using the methods and assays described herein. Other agents are added typically at a concentration range of approximately 1 to approximately 5%. Proteins, such as human serum albumin, bovine serum albumin, fetal bovine serum, egg yolk, skim milk, gelatin, casein or oviductin, may also be added.

Such medium may also be prepared by adding the 4-thioderivative of flavan-3-ol of formula (I) to a commercial cryopreservative solution, such as Nidacon Sperm CryoProtect.

Cryoprotective medium may typically be added slowly to the cells in a drop wise fashion. The addition of the cryoprotective medium may be done at about 4° C., about 37° C. or at about room temperature, depending on the permeability of the cryoprotectant used.

Following suspension of the cells in the cryoprotective medium (e.g., for storage), the container may be sealed and subsequently either refrigerated or frozen. Briefly, for refrigeration, the sample may be placed in a refrigerator in a container filled with water for one hour or until the temperature reaches about 4° C. Samples may be then placed in Styrofoam containers with cool packs and may be shipped for insemination, in the case of sperm, the next day. If the sample is to be frozen, the cold sample may be aliquoted into cryovials or straws and placed in the vapor phase of liquid nitrogen for one to two hours, and then plunged into the liquid phase of liquid nitrogen for long-term storage or frozen in a programmable computerized freezer. Frozen samples may be thawed by warming in an about 37° C. water bath and may be directly inseminated or washed prior to insemination. Other cooling and freezing protocols may be used.

Vitrification may be used for storing oocytes and embryos. Vitrification may involve dehydration of the oocyte or embryos using sugars, Ficoll, or the like. The oocyte or embryo may then be added to a cryoprotectant and rapidly moved into liquid nitrogen.

Within one or more of the present formulations, biological samples, and particularly, sperm, oocytes, or embryos, may be prepared and stored as described above.

4-Thioderivatives of Flavan-3-Ol of Formula (I)

The term linear or branched C₁-C₄ alkyl, as used herein, is meant a lineal or branched alkyl group which contains up to 4 atoms of carbon; for example, methyl, ethyl, propyl, isopropyl, butyl, isobutyl, sec-butyl and tert-butyl.

The compounds of formula (I) may be derivatives of the following natural flavan-3-ols: Epicathechin, epigallocatechin, catechin, gallocatechin and the corresponding 3-O-gallates.

In the compounds of formula (I), B may be a single bond and n may be preferably 2; or B may be 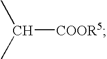
and n may be preferably 1; R⁴ may be preferably H or CH₃CO—; R⁵ may be preferably H, methyl or ethyl.

The compounds of formula (I) may have a chiral centre in the 4 position. They may have an alpha or beta configuration. It is understood that the compositions hereof may include such stereoisomers and mixtures thereof in any proportion that possesses cryoprotective effect.

The compounds of formula (I) with a beta configuration in the four position (i.e. 4β isomers) are preferred, and more preferred are compounds of formula (I) selected from 4β-[S—(N-acetyl-O-methyl-cysteinyl)]epicatechin and 4β-(S-cysteinyl)epicatechin.

Salts of compounds of formula (I) may include salts of alkaline metals such as sodium or potassium and salts of alkaline earth metals such as calcium or magnesium, as well as acid-addition salts formed with inorganic and organic acids such as hydrochlorides, hydrobromides, sulphates, nitrates, phosphates, formates, mesylates, citrates, benzoates, fumarates, maleates, lactates, succinates and trifluoroacetates among others.

Salts of compounds of formula (I) may be prepared by reaction of a compound of formula (I) with a suitable quantity of a base such as sodium, potassium, calcium or magnesium hydroxide, or sodium methoxide, sodium hydride, potassium tert-butoxide and the like in solvents such as ether, THF, methanol, ethanol, tert-butanol, isopropanol, dioxane, etc., or a mixture of solvents. The addition salts, where applicable, may be prepared by treatment with acids, such as hydrochloric, hydrobromic, sulphuric, nitric, phosphoric, formic, methanesulphonic, citric, benzoic, fumaric, maleic, lactic, succinic or trifluoroacetic acid, in solvents such as ether, alcohols, acetone, THF, ethyl acetate, or mixtures of solvents.

Compounds of formula (Ia) may include compounds of formula (I) wherein n is 2, B is a single bond and R⁴ is H. Compounds of formula (Ia) were first described in the international patent application WO02051829A1 as antioxidant agents and may be obtained according to the methods described therein and in Torres, J. L.; Bobet, R. J. Agric. Food Chem. 2001, 49, 4627. The compounds of formula (I) wherein B is a single bond and R4 is H and n is 1 or 3 to 6 are new and may be obtained in a similar way as described for compounds of formula (Ia), by substituting the thioethylamine (n=2) with the corresponding thioalkylamine wherein said alkyl is (CH₂)ₙ and n is 1 or 3 to 6. The compounds of formula (I) wherein B is a single bond and R⁴ is —C(O)—R⁶, linear or branched C₁-C₄ alkyl, or a natural amino acid selected from the group defined above, are new and may be obtained in a similar way as described in WO02051829A1, by substituting the thioethylamine (n=2) with the corresponding compound of formula (III): R⁴HN—(CH₂)ₙ—SH, wherein R⁴ and n are as defined above.

Compounds of formula (Ib) may include compounds of formula (I) wherein n is 1, R⁴ is H and B is CH—COOH. Compounds of formula (Ib) were first described in WO 03024951 as antioxidant agents and may be obtained according to the methods described therein and in Torres, J. L. et al. Bioorg. Med. Chem. 2002, 10, 2497. The compounds of formula (I) wherein R⁴ is H and B is CH—COOH and n is 2 to 6 are new and may be obtained in a similar way as described for compounds of formula (Ib), but using instead of the cysteine (n=1) an amino acid of formula (IV)

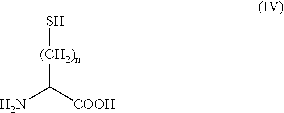

wherein n is 2 to 6.

The reactions are carried out in the solvents appropriate for the reagents and materials used and suited for the transformations carried out. An expert in organic synthesis would likely understand that the functional groups present in the molecule should be consistent with the proposed transformations. This may in some cases require modifying the order of the synthesis steps or selecting one particular method rather than another, in order to obtain the desired compound of the invention. Moreover, in some of the procedures described above it may be desirable or necessary to protect the reactive functional groups present in the compounds or intermediates of this invention with conventional protecting groups. Various protecting groups and procedures for introducing them and removing them are described in Greene and Wuts (Protective Groups in Organic Synthesis, Wiley and Sons, 1999).

Cellular Damage Resulting from Storage

There are different methods for evaluating the cellular damage described in the literature. Some of them are very specific and dependant on the kind of cell. It is within the skilled person's general knowledge to identify a suitable method with respect to a specific cell type of interest. Relevant viability parameters of a cell population may be measured before and after storage to identify the degree of cellular damage after storage.

Below are certain methods for evaluating the cellular damage resulting from storage of sperm and embryos.

Methods for Evaluating the Reduced Cellular Damage Resulting from Storage of Sperm

The function of sperm is to fertilize an oocyte. The cellular damage resulting from storage of sperm may decrease sperm capability for performing this function. This function may be assayed by a broad range of measurable cell functions. Such assayable functions may include sperm motility, sperm viability, membrane integrity of sperm, in vitro fertilization, sperm chromatin stability, survival time in culture, penetration of cervical mucus, as well as sperm penetration assays and hemizona assays.

Sperm motility is one function that may be used to assess sperm function and thus fertilization potential. Motility of sperm may be expressed as the total percent of motile sperm, the total percent of progressively motile sperm (swimming forward), or the speed of sperm that are progressively motile. These measurements may be made by a variety of assays, as described herein. A subjective visual determination may be made using a phase contrast microscope where the sperm are placed in a hemocytometer or on a microscope slide, or using a computer-assisted semen analyzer. Under phase contrast microscopy, motile and total sperm counts are made and speed is assessed as fast, medium or slow. Using a computer assisted semen analyzer (Hamilton Thom, Beverly, Mass.), the motility characteristics of individual sperm cells in a sample may be determined by placing a sperm sample onto a slide or chamber designed for the analyzer. The analyzer may track individual sperm cells and determines motility and velocity of the sperm. Data may be expressed as percent motile, and measurements obtained for path velocity and track speed as well.

Sperm viability may be measured in one of several different methods. By way of example, two of these methods are staining with membrane exclusion stains and measurement of ATP levels. Briefly, a sample of sperm is incubated with a viable dye, such as Hoechst 33258 or eosin-nigrosin stain. Cells are placed in a hemocytometer and examined microscopically. Dead sperm with disrupted membranes stain with these dyes. The number of cells that are unstained is divided by the total number of cells counted to give the percent live cells. ATP levels in a sperm sample may be measured as follows by lysing the sperm and incubating the lysate with luciferase, an enzyme obtained from fireflies, which fluoresces in the presence of ATP. The fluorescence is measured in a luminometer (Sperm Viability Test; Firezyme, Nova Scotia, Canada). The amount of fluorescence in the sample is compared to the amount of fluorescence in a standard curve, allowing a determination of the number of live sperm present in the sample.

Membrane integrity of sperm is typically assayed by a hypo-osmotic swell test which measures the ability of sperm to pump water or salts if exposed to nonisotonic environments. Briefly, in the hypo-osmotic swell test, sperm are suspended in a solution of 75 mM fructose and 25 mM sodium citrate, which is a hypo-osmotic (150 mOsm) solution. Sperm with intact, healthy membranes pump salt out of the cell, causing the membranes to shrink as the cell grows smaller. The sperm tail curls inside this tighter membrane. Thus, sperm with curled tail are counted as live, healthy sperm with normal membranes. When compared to the total number of sperm present, a percentage of functional sperm may be established.

The degree of membrane integrity may be determined by lipid peroxidation (LPO) measurements, which assess sperm membrane damage generated by free radicals released during handling. Lipid membrane peroxidation may be assayed by incubating sperm with ferrous sulfate and ascorbic acid for one hour in a 37° C. water bath. Proteins are precipitated with ice-cold trichloroacetic acid. The supernatant is collected by centrifugation and reacted by boiling with thiobarbituric acid and NaOH. The resultant malondialdehyde (MDA) formation is quantified by measuring absorbance at 534 nm as compared to an MDA standard (M. Bell et al. J. Andrology 14:472-478, 1993)). LPO is expressed as nM MDA/10⁸ sperm. A stabilizing effect results in decreased LPO production.

The stability of chromatin DNA may be assayed using the sperm chromatin sensitivity assay (SCSA). This assay is based on the metachromatic staining of single and double stranded DNA by acridine orange stain, following excitation with 488 nm light. Green fluorescence indicates double strand DNA, and red fluorescence indicates single strand DNA. The extent of DNA denaturation in a sample is expressed as a and calculated by the formula (α=red/(red+green)). In all cases, sperm are mixed with TNE buffer (0.01 M Trisaminomethane-HCl, 0.015M NaCl, and 1 mM EDTA) and flash frozen. Sperm samples are then subjected to 0.01% Triton-X, 0.08N HCl and 0.15M NaCl, which induces partial denaturation of DNA in sperm with abnormal chromatin. Sperm are stained with 6 g/ml acridine orange and run through a flow cytometer to determine α.

In vitro fertilization rates may be determined by measuring the percent fertilization of oocytes in vitro. Maturing oocytes are cultured in vitro in Ml 99 medium plus 7.5% fetal calf serum and 50 μg/ml luteinizing hormone for 22 hours. Following culture for 4 hours, the sperm are chemically capacitated by adding 10 IU of heparin and incubated with oocytes for 24 hours. At the end of the incubation, oocytes are stained with an aceto-orcein stain or equivalent to determine the percent oocytes fertilized. Alternatively, fertilized oocytes may be left in culture for 2 days, during which division occurs and the numbers of cleaving embryos (i.e., 2 or more cells) are counted.

Survival time in culture of sperm (time to loss of motility) may be another convenient method of establishing sperm function. This parameter correlates well with actual fertility of a given male. Briefly, an aliquot of sperm is placed in culture medium, such as Tyrodes medium, pH 7.4 and incubated at 37° C., 5% CO₂, in a humidified atmosphere. At timed intervals, for example every 8 hours, the percentage of motile sperm in the culture is determined by visual analysis using an inverted microscope or with a computer assisted sperm analyzer. As an endpoint, a sperm sample is considered no longer viable when less than 5% of the cells have progressive motility.

Another parameter of sperm function is the ability to penetrate cervical mucus. This penetration test may be done either in vitro or in vivo. Briefly, in vitro, a commercial kit containing cervical mucus (Tru-Trax, Fertility Technologies, Natick, Mass.), typically bovine cervical mucus, is prepared. Sperm are placed at one end of the track and the distance that sperm have penetrated into the mucus after a given time period is determined. Alternatively, sperm penetration of mucus may be measured in vivo in women. At various times post-insemination, a sample of cervical mucus is removed and examined microscopically for the number of sperm present in the sample.

Other assays of sperm function potential may include the sperm penetration and hemizona assays. In a sperm penetration assay, the ability of sperm to penetrate into an oocyte is measured. Briefly, commercially available zona free hamster oocytes are used (Fertility Technologies, Natick, Mass.). Hamster oocytes are suitable in this assay for sperm of any species. Capacitated sperm, such as those cultured with bovine serum albumin for 18 hours, are incubated for 3 hours with the hamster oocytes. Following incubation, oocytes are stained with acetolacmoid or equivalent stain and the number of sperm penetrating each oocyte is counted microscopically. A hemizona assay measures the ability of sperm to undergo capacitation and bind to an oocyte. Briefly, in this assay, live normal sperm are incubated in media with bovine serum albumin, which triggers capacitation. Sperm are then incubated with dead oocytes which are surrounded by the zona pellucida, an acellular coating of oocytes. Capacitated sperm bind to the zona and the number of sperm binding is counted microscopically.

Methods for Evaluating the Reduced Cellular Damage Resulting from Storage of Embryos

For embryos, viability and quality may be ascertained by a correct embryo cell division rate during culture time, which may be: day 1, two-cell stage; day 2, four-cell stage; day 3, eight-cell stage; and day 4, blastocyst stage.

The derivatives of flavan-3-ol may be used in the medium at a concentration sufficient to reduce cellular damage after storage in a refrigerated, frozen or vitrified state. Based on the present disclosure and on general knowledge, it would be expected that one skilled in the art could adequately adjust the flavan-3-ol concentration to a degree of reduced cellular damage of interest.

The derivatives of flavan-3-ol as described herein may have a good cryoprotective effect, and may therefore be used in a relatively low concentration and still result in reduced cellular damage.

One medium for storing a biological sample may have a concentration of the derivatives of flavan-3-ol from about 15 μg/mL to about 500 μg/mL, possibly from about 25 μg/mL to about 200 μg/mL and also possibly from about 50 μg/mL to about 150 μg/mL.

The concentration may be measured in the stored sample, i.e. the medium and the biologic sample comprising the cells to be stored.

The reduction of cell damage after storage may represent an improvement of at least about 5% as compared to storage under similar conditions in similar control storage medium without the derivatives of flavan-3-ol as described herein.

In other words, if the viability of cells (e.g. sperm cells) after storage in a medium without the derivatives of flavan-3-ol is about 47% and the viability of the cells after storage in the same medium comprising the derivatives of flavan-3-ol is about 70% the reduction of cell damage after storage represents an improvement of about 49%. Table 1 of example 7 illustrates similar improvements for storage of sperm cells.

Accordingly, the reduction of cell damage after storage may represent an improvement of at least about 10% as compared to storage under similar conditions in similar control storage medium without the derivatives of flavan-3-ol as described herein, even more preferably an improvement of at least about 25% and possibly an improvement of at least about 35%.

4-Thioderivatives of Flavan-3-Ol of General Formula (II)

The 4-thioderivatives of flavan-3-ol of general formula (II) are new. These may be as follows: 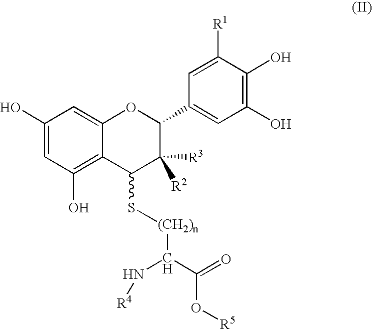
wherein:
R¹, R² and R³ may be as defined above,
n may be 1-6,
R⁴ may be H, —C(O)—R⁶, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;
R⁵ may be H, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;
R⁶ may be linear or branched C₁-C₄ alkyl;
and when R⁴ is H, then R⁵ is different from H.

In many instances of the compounds of general formula (II), when n is 1; R⁴ may be H or CH₃CO—; and, R⁵ may be H, methyl or ethyl.

The compounds of formula (II) may have a chiral centre in the 4 position. They may have an alpha or beta configuration, for example, a beta configuration in the four position (i.e. 4β isomers). These compounds may include such stereoisomers and mixtures thereof in any proportion that possess cryoprotective effect.

Salts of compounds of formula (II) may include salts of alkaline metals such as sodium or potassium and salts of alkaline earth metals such as calcium or magnesium, as well as acid-addition salts formed with inorganic and organic acids such hydrochlorides, hydrobromides, sulphates, nitrates, phosphates, formates, mesylates, citrates, benzoates, fumarates, maleates, lactates, succinates and trifluoroacetates, among others.

Salts of compounds of formula (II) may be prepared by reaction of a compound of formula (II) with a suitable quantity of a base such as sodium, potassium, calcium or magnesium hydroxide, or sodium methoxide, sodium hydride, potassium tert-butoxide and the like in solvents such as ether, THF, methanol, ethanol, tert-butanol, isopropanol, dioxane, etc., or else in a mixture of solvents. The addition salts, where applicable, may be prepared by treatment with acids, such as hydrochloric, hydrobromic, sulphuric, nitric, phosphoric, formic, methanesulphonic, citric, benzoic, fumaric, maleic, lactic, succinic or trifluoroacetic acid, in solvents such as ether, alcohols, acetone, THF, ethyl acetate, or mixtures of solvents.

The compound of formula (II) may be 4β-[S—(N-acetyl-O-methyl-cysteinyl)]epicatechin.

Methods for preparing compounds of formula (II) may include, but are not limited to, those described below. The reactions may be carried out in the solvents appropriate for the reagents and materials used and suited for the transformations carried out. An artisan in organic synthesis would understand that the functional groups present in the molecule should be consistent with the proposed transformations. This may, in some cases, require modifying the order of the synthesis steps or selecting one particular method rather than another, in order to obtain the desired compound hereof. Moreover, in some of the procedures described below, it may be desirable or necessary to protect the reagent functional groups present in the compounds or intermediates hereof with conventional protecting groups. Various protecting groups and procedures for introducing them and removing them are described in Greene and Wuts (Protective Groups in Organic Synthesis, Wiley and Sons, 1999).

Compounds of formula (II), like compounds of formula (Ib), may be derivatives of natural flavan-3-ols epicathechin, epigallocatechin, catechin, gallocatechin and the corresponding 3-O-gallates. Therefore, compounds of formula (II) may be prepared by a process similar to the process for preparing compounds of formula (Ib), described in Torres, J. L. et al. Bioorg. Med. Chem. 2002, 10, 2497 and WO 03024951. This preparation may thus include three phases; an extraction phase, a thiolysis phase and finally isolation and purification, described therein in detail. While the same extraction phase of polyphenols from the first plant source may be applied, the thiolysis phase ordinarily is not performed with cysteine, but with a different amino acid derivative.

Thus, compounds of formula (II) may be obtained by acid depolymerisation of an extract containing procyanidins/prodelfinidins treated with a compound of general formula (V): 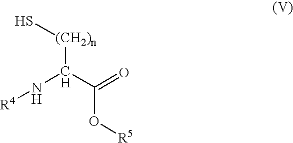
wherein n, R⁴ and R⁵ may be as defined above, followed by purification, essentially as described in Torres, J. L. et al. Bioorg. Med. Chem. 2002, 10, 2497.

This purification typically utilizes preparative RP-HPLC (reversed-phase high performance liquid chromatography) fractionation.

Compounds of formula (II) wherein R⁴ is H may be separated from the crude depolymerisation mixture on a strong cation-exchange resin (e.g. MacroPrep™ High S 50 μm) by taking advantage of the free amino function.

Compounds of formula (II) wherein R⁴ is as defined above except H, may be separated from the crude depolymerisation mixture by preparative RP-HPLC fractionation, done directly from the depolymerised mixture.

Compounds of formula (II) wherein R⁵ is methyl may also be obtained from a compound of formula (V), wherein R⁵ is H, if the depolymerisation conditions are about 60° C., HCl, methanol, and about 15 min.

Typically, compounds with the 4β configuration are the major isomers obtained irrespective of the 2,3-stereochemistry.

Compounds of formula (III), (IV) and (V) wherein R⁴ and R⁵ are amino acids selected from the group defined above, may be obtained from the corresponding compounds of formula (III), (IV) and (V) wherein R⁴ and R⁵ are H, using reactions well known in the chemistry of peptides.

The compounds of formula (III), (IV) and (V) wherein R⁴ and R⁵ are as defined above, except that they are not amino acids, are commercial, are extensively described in the literature or can be prepared by methods analogous to those known by those skilled in the art from products commercially available.

### EXAMPLES

Acid Depolymerisation of Procyanidins in the Presence of Thiols.

To obtain the thio-conjugates of examples 1 to 6 the solvent (water saturated with ethyl acetate) was eliminated from an aliquot (400 mL, 4 g gallic acid equivalents, 6 g estimated polyphenols by weight, coming from 3.2 kg of grape byproduct) of the source of procyanidins. The pellet was then dissolved in MeOH (400 mL) and dried. This operation was repeated three times in order to eliminate moisture. The resulting syrupy residue was dissolved in MeOH (400 mL) and a solution of the appropriate cysteine derivative (20 g) and 37% HCl (10 mL) in MeOH (400 mL) was added. The mixture was kept at 65° C. for 20 min under agitation. The reaction was then quenched with cold water (3.2 L).

Ion-Exchange Separation of the O-Ethyl-Cysteinyl Derivatives from the Depolymerised Mixtures and Fractionation by Preparative RP-HPLC.

To set-up the separation conditions at milligram scale semi-preparative runs were performed on a 6 mL bed volume column loaded with MacroPrep™ High S resin. The preparative separations were performed on a 105 mL bed volume column loaded with the same stationary phase. The eluents were [A]: 20 mM sodium phosphate, pH 2.3 buffer/EtOH (13:7) and [B]: 20 mM sodium phosphate, pH 2.3 buffer/EtOH (3:2), 100 mM NaCl. The column was equilibrated with eluent [A], loaded with the quenched depolymerised mixture (500 mL) and washed with [A] (500 mL, 4.75 bed volumes). The retained flavan-3-ol-derivatives were released with 500 mL (4.75 bed volumes) of eluent [B]. The column was then washed with 7.14 bed volumes (750 mL) of 20 mM sodium phosphate buffer, pH 2.25/EtOH (3:2), 1 M NaCl. The operation was repeated (7 times total) until the whole mixture was consumed. The separation process was monitored by analytical RP-HPLC on a VYDAC™ C₁₈ column eluted with a binary system, [C]: 0.10% (v/v) aqueous TFA, [D]: 0.09% (v/v) TFA in water/CH₃CN (1:4) under isocratic conditions 19% [D] at a flow rate of 1.5 mL/min and detection at 214 nm, 0.016 absorbance units full scale (aufs). The eluates containing the corresponding conjugate were pooled (3.5 L), the solvent volume was reduced under vacuum down to 1.6 L, and water was added up to a final volume of 3.2 L. The RP-HPLC profile of the pooled eluates as well as the initial and final washing steps were recorded on the same analytical system under gradient conditions 8 to 23% [D] over 45 min at a flow rate of 1.5 mL/min with detection at 214 nm.

The mixture containing the O-ethyl-cysteinyl conjugates of examples 1 to 3 was fractionated on a preparative RP-HPLC cartridge filled with VYDAC™ C18 stationary phase by a CH₃CN gradient in 0.10% (v/v) aqueous TFA (4% to 20% CH₃CN over 45 min). The solution (3.2 L) was processed in four portions of approximately ˜800 mL each. Fractions enriched in each of the three compounds were obtained: fraction I, 9% to 11% CH₃CN, compound of example 2; fraction II, 12% to 16% CH₃CN, compound of example 1; fraction III, 17% to 19% CH₃CN, compound of example 3.

Purification of the O-Ethyl Cysteinyl Derivatives

The 4β-[S—(O-ethyl-cysteinyl)]flavan-3-ols may be purified from fractions I-III by preparative RP-HPLC and identified by mass spectrometry and nuclear magnetic resonance.

### Example 1

### 4β-[S—(O-ethyl-cysteinyl)]epicatechin

Fraction II (4.3 L) from reversed-phase fractionation was concentrated (2.3 L final volume) under vacuum to eliminate most of the CH₃CN, loaded onto the preparative cartridge and eluted using a CH₃CN gradient (4 to 20% over 60 min) in triethylamine phosphate pH 2.25 buffer at a flow rate of 100 mL/min, with detection at 230 nm. The resulting fractions enriched with the compound of the title were pooled, diluted with water (1:1) and re-chromatographed on the same cartridge by a gradient (2 to 18% [D] over 30 min). The compound of the title eluted at 15% to 18% CH₃CN. Analysis of the fractions was accomplished under isocratic conditions in 0.10% (v/v) aqueous TFA/CH₃CN using the VYDAC™ C₁₈ column, solvent system, flow rate and detection described above with isocratic elution at 19% [D]. The pure fractions were pooled and desalted by a fast CH₃CN gradient in 0.10% (v/v) aqueous TFA on the same cartridge. 4β-[S—(O-ethyl-cysteinyl)]epicatechin (354 mg) was obtained as the trifluoroacetate by lyophilisation. ES-MS, positive ions, m/z 438.1 (M+1)⁺, calculated for C₂₀H₂₄N₁O₈S₁ (M+H)⁺ 438.1. ¹H-NMR ((CD₃)₂CO+3 drops D₂O, 300 MHz): δ 1.24 (3H, t J=7.2, O—CH₂—CH₃); 3.93 (1H, d J=2.1 Hz, 4-H 3,4-trans configuration); 4.06 (1H, dd J=2.4, 0.9 Hz, 3-H); 4.26 (2H, quadruplet J=7.2, 1.5 Hz, O—CH₂—CH₃); 4.71 (1H, m, S—CH₂—CH<); 5.09 (1H, s, 2-H 2,3-cis configuration); 5.90 (1H, d J=2.4 Hz, 8-H); 6.09 (1H, d J=2.4 Hz, 6-H); 6.80-6.81 (2H, m, 5′-H, 6′-H); 7.04 (1H, d J=1.8 Hz, 2′-H). Purity (>95%) was ascertained by RP-HPLC on a μRPC C2/C18, 3 μm column; elution, [C]: 0.10% (v/v) aqueous TFA, [D]: 0.09% (v/v) TFA in water/CH₃CN (1:4), gradient 8 to 23% [D] over 45 min at a flow rate of 200 μL/min with substantially simultaneous detection at 214, 280 and 320 nm.

### Example 2

### 4β-[S—(O-ethyl-cysteinyl)]catechin

Fraction I from reversed-phase fractionation was concentrated as stated in example 1, loaded onto the preparative cartridge and eluted using a CH₃CN gradient (2 to 18% over 60 min) in triethylamine phosphate pH 2.25 buffer, at a flow rate of 100 mL/min, with detection at 230 nm. Analysis of the fractions was accomplished under isocratic conditions in 0.10% (v/v) aqueous TFA/CH₃CN using the VYDAC™ C₁₈ column, solvent system, flow rate and detection described above with isocratic elution at 19% [D]. The best fractions were pooled, diluted, re-loaded onto the cartridge and eluted with a CH₃CN gradient (2 to 18% over 60 min) in triethylamine phosphate pH 5.62 buffer. The purest fractions were pooled, desalted with a steep CH₃CN gradient in 0.10% (v/v) aqueous TFA and lyophilised. Then the preparation was re-chromatographed on a semi-preparative Perkin-Elmer C18 cartridge eluted with 18% CH₃CN in 0.10% (v/v) aqueous TFA under isocratic conditions. After pooling the best fractions and lyophilization, 4β-[S—(O-ethyl-cysteinyl)]catechin (68 mg) was obtained as the trifluoroacetate. ES-MS, positive ions, m/z 438.1 (M+1)⁺, calculated for C₂₀H₂₄N₁O₈S₁ (M+H)⁺ 438.1. ¹H-NMR ((CD₃)₂CO+3 drops D₂O, 300 MHz): δ 1.24 (3H, t J=7.0, O—CH₂—CH₃); 4.06 (1H, 2d J=9.6, 2.4 Hz, 3-H 2,3-trans configuration); 4.23 (1H, d J=2.4 Hz, 4-H 3,4-cis configuration); 4.26 (2H, quadruplet J=7.0, 2.4 Hz, O—CH₂—CH₃); 4.72-4.76 (1H, m, S—CH₂—CH<; 1H, 2-H); 5.89 (1H, d J=2.4 Hz, 8-H); 6.10 (1H, d J=2.4 Hz, 6-H);□6.62 (2H, m, 5′-H, 6′-H); 6.91 (1H, s, 2′-H). Purity (>93%) was ascertained by RP-HPLC on the system described for compound of example 1.

### Example 3

### 4β-[S—(O-ethyl-cysteinyl)]epicatechin 3-O-gallate

Fraction III from reversed-phase fractionation was concentrated as stated in example 1, loaded onto the preparative cartridge and eluted using a CH₃CN gradient (8 to 24% over 60 min) in triethylamine phosphate pH 2.25 buffer, at a flow rate of 100 mL/min, with detection at 230 nm. Fractions were analysed under isocratic conditions in 0.10% (v/v) aqueous TFA/CH₃CN using the column, solvent system, flow rate and detection described above with elution at 21% [D]. The best fractions were pooled, diluted, re-loaded onto the cartridge and eluted with a CH₃CN gradient (8 to 24% over 60 min) in triethylamine phosphate pH 5.62 buffer. The purest fractions were pooled and re-chromatographed with a CH₃CN gradient (10 to 26% over 30 min) in 0.10% (v/v) aqueous TFA. Then the preparation was re-chromatographed on a semi-preparative Perkin-Elmer C18 cartridge eluted with a CH₃CN gradient (12 to 28% over 30 min) in 0.10% (v/v) aqueous TFA. After lyophilization, 4β-[S—(O-ethylcysteinyl)]epicatechin 3-O-gallate (33 mg) was obtained as the trifluoroacetate. ES-MS, positive ions, m/z 590.1 (M+1)⁺ calculated for C₂₇H₂₈N₁O₁₂S₁ (M+H)⁺ 590.1. ¹H-NMR ((CD₃)₂CO+3 drops D₂O, 300 MHz): δ 1.28 (3H, t J=7.0, O—CH₂—CH₃); 4.15 (1H, d J=1.8 Hz, 4-H 3,4-trans configuration); 4.29 (2H, quadruplet J=7.0, 1.8 Hz, O—CH₂—CH₃); 4.77 (1H, m, S—CH₂—CH<); □5.28 (1H, 2m, 3-H); 5.36 (1H, bs, 2-H 2,3-cis configuration); 6.01 (1H, d J=2.1 Hz, 6-H); 6.13 (1H, d J=2.1 Hz, 8-H); 6.79 (1H, d J=8.1 Hz, 5′-H); 6.88 (1H, dd J=8.4, 2.1 Hz, 6′-H); 6.96 (2H, s, galloyl-H); 7.10 (1H, d J=1.8 Hz, 2′-H). Purity (>96%) was ascertained by RP-HPLC on the system described for compound of example 1.

Purification of the N-Acetyl-O-Methyl-Cysteinyl Derivatives

The preparative RP-HPLC fractionation of the N-acetyl-O-methyl-cysteinyl conjugates of examples 4 to 6 was done directly from the depolymerised mixture under chromatographic conditions (6% to 20% CH₃CN over 54 min) similar to the conditions described for the ethyl-cysteine conjugates. Fractions of interest: fraction IV, 13% to 14% CH₃CN, compound of example 5; fraction V, 15% to 18% CH₃CN, compound of example 4; fraction VI, 18% to 19% CH₃CN, compound of example 6.

The 4β-[S—(N-acetyl-O-methyl-cysteinyl)]flavan-3-ols were purified from fractions IV-VI by preparative RP-HPLC and identified by mass spectrometry and nuclear magnetic resonance.

### Example 4

### 4β-[S—(N-acetyl-O-methyl-cysteinyl)]epicatechin

Fraction V (3.4 L) from reversed-phase fractionation was concentrated (1.5 L final volume) under vacuum to eliminate most of the CH₃CN, loaded onto the preparative cartridge and eluted using a CH₃CN gradient (6 to 22% over 60 min) in triethylamine phosphate pH 2.32 buffer, at a flow rate of 100 mL/min, with detection at 230 nm. The resulting fractions enriched with the compound of the title were pooled, diluted with water (1:1) and re-chromatographed on the same cartridge by a gradient (6 to 22% [D] over 30 min). Analysis of the fractions was accomplished under isocratic conditions in 0.10% (v/v) aqueous TFA/CH₃CN using the VYDAC™ C₁₈ column, solvent system, flow rate and detection described above with isocratic elution at 17% [D]. The pure fractions were pooled, diluted with water (1:1) and re-chromatographed on the same cartridge by a CH₃CN gradient (6 to 22% over 60 min) in triethylamine phosphate pH 5.66 buffer. The purest fractions were pooled and desalted by a fast CH₃CN gradient in 0.10% (v/v) aqueous TFA on the same cartridge. 4β-[S—(N-acetyl-O-methyl-cysteinyl)]epicatechin (818 mg) was obtained by lyophilization. ES-MS, negative ions, m/z 464.7 (M−1)⁻, calculated for C₂₁H₂₃N₁O₉S₁ (M−H)⁻ 464.5. ¹H-NMR ((CD₃)₂CO+3 drops D₂O, 300 MHz): δ 2.05 (3H, s, CO—CH₃); 3.69 (3H, s, O—CH₃); 4.02 (1H, dd J=2.4, 1.2 Hz, 3-H 2,3-cis configuration); 4.06 (1H, d J=2.4 Hz, 4-H 3,4-trans configuration); 4.94 (1H, m, S—CH₂—CH<); 5.22 (1H, s, 2-H); 5.89 (1H, d J=2.4 Hz, 8-H); 6.06 (1H, d J=2.4 Hz, 6-H); 6.81-6.83 (2H, m, 5′-H, 6′-H); 7.06 (1H, d J=2.1 Hz, 2′-H). Purity (>99%) was ascertained by RP-HPLC on the system described for compound of example 1.

### Example 5

### 4β-[S—(N-acetyl-O-methyl-cysteinyl)]catechin

Fraction IV from reversed-phase fractionation was concentrated as stated in example 1, loaded onto the preparative cartridge and eluted using a CH₃CN gradient (6 to 22% over 60 min) in triethylamine phosphate pH 2.45 buffer, at a flow rate of 100 mL/min, with detection at 230 nm. Analysis of the fractions was accomplished under isocratic conditions in 0.10% (v/v) aqueous TFA/CH₃CN using the VYDAC™ C₁₈ column, solvent system, flow rate and detection described above with isocratic elution at 17% [D]. The best fractions were pooled, diluted, re-loaded onto the cartridge and eluted with a CH₃CN gradient (2 to 18% over 60 min) in triethylamine phosphate pH 4.90 buffer. The purest fractions were pooled, desalted with a steep CH₃CN gradient in 0.10% (v/v) aqueous TFA and lyophilised. Then the preparation was re-chromatographed on a semi-preparative Perkin-Elmer C18 cartridge eluted with 16% CH₃CN in 0.10% (v/v) aqueous TFA under isocratic conditions. After pooling the best fractions and lyophilization, 4β-[S—(N-acetyl-O-methyl-cysteinyl)]catechin (64 mg) was obtained. ES-MS, negative ions, m/z 464.9 (M−1)⁻, calculated for C₂₁H₂₃N₁O₉S₁ (M−H)⁻ 464.5. ¹H-NMR ((CD₃)₂CO+3 drops D₂O, 300 MHz): δ 2.11 (3H, s, CO—CH₃); 3.65 (3H, s, O—CH₃); 4.15 (1H, 2d J=9.6, 3.9 Hz, 3-H); 4.38 (1H, d J=3.9 Hz, 4-H 3,4-cis configuration); 4.82 (1H, m, S—CH₂—CH<); 495 (1H, d J=9.6 Hz, 2-H 2,3-trans configuration); 5.78 (1H, d J=2.4 Hz, 8-H); 6.06 (1H, d J=2.4 Hz, 6-H);□6.78 (2H, m, 5′-H, 6′-H); 6.92 (1H, s, 2′-H). Purity (99%) was ascertained by RP-HPLC on the system described for compound of example 1.

### Example 6

### 4β-[S—(N-acetyl-O-methyl-cysteinyl)]epicatechin 3-O-gallate

Fraction VI from reversed-phase fractionation was concentrated as stated in example 1, loaded onto the preparative cartridge and eluted using a CH₃CN gradient (10 to 26% over 30 min) in 0.10% (v/v) aqueous TFA, at a flow rate of 100 mL/min, with detection at 230 nm. Fractions were analysed under isocratic conditions in 0.10% (v/v) aqueous TFA/CH₃CN using the column, solvent system, flow rate and detection described above with elution at 22% [D]. The best fractions were pooled, diluted, re-loaded onto the cartridge and eluted with a CH₃CN gradient (11 to 27% over 60 min) in triethylamine phosphate pH 5.0 buffer. The purest fractions were pooled and re-chromatographed with 22% CH₃CN in 0.10% (v/v) aqueous TFA under isocratic conditions. After lyophilization, 4β-[S—(N-acetyl-O-methyl-cysteinyl)]epicatechin 3-O-gallate (88 mg) was obtained. ES-MS, negative ions, m/z 616.3 (M−1)⁻ calculated for C₂₈H₂₇N₁O₁₃S₁ (M−H)⁻ 616.6. ¹H-NMR ((CD₃)₂CO+3 drops D₂O, 300 MHz): δ 2.09 (3H, s, CO—CH₃); 3.71 (3H, s, O—CH₃); 4.26 (1H, d J=2.4 Hz, 4-H 3,4-trans configuration); 5.01 (1H, m, S—CH₂—CH<); 5.21 (1H, m, 3-H); 5.48 (1H, bs, 2-H 2,3-cis configuration); 6.01 (1H, d J=2.4 Hz, 8-H); 6.07 (1H, d J=2.4 Hz, 6-H); 6.78 (1H, d J=8.1 Hz, 5′-H); 6.89 (1H, dd J=8.1, 2.1 Hz, 6′-H); 6.96 (2H, s, galloyl-H); 7.08 (1H, d J=2.1 Hz, 2′-H). Purity (95%) was ascertained by RP-HPLC on the system described for compound of example 1.

### Example 7

### Effect of Supplementation with 4-Thioderivative of Flavan-3-Ol on Postthaw Sperm Function in Comparison with the Effect of a Natural Flavan-3-Ol

Introduction:

This example provides a comparison between the effect on postthaw sperm of supplementing the freezing medium with a natural flavan-3-ol and with 4-thioderivatives thereof according to the present disclosure.

It shows that (−)-epicatechin, a natural flavan-3-ol, exerts no significant protection, evaluated in terms of sperm motility, at concentrations ranging from 1 to 100 μg/mL. In contrast and surprisingly, it also shows that 4-thioderivatives of said flavan-3-ol according hereto may exert a protection improvement of around 40% at low concentration of 50 microg/mL or 100 microM, with very high confidence (p less than 0.001).

Materials and Methods

Aliquots of 50 μL of solutions of different 4-thioderivatives of flavan-3-ol of formula (I) hereof dissolved in PureSperm Wash medium (Nidacon International, Sweden), were added to 0.95 mL of the spermatozoa suspension (50 millions/mL) in CryoProtec freezing medium (Nidacon International, Sweden) in 1.8 mL Nunc vials in order to obtain final concentrations of 1, 10, 25, 50 and 100 μg/mL. Aliquots of 50 μL of solutions of (−)-epicatechin, a natural flavan-3-ol, were treated in the same way. As a control, 50 μL of PureSperm Wash medium (Nidacon International) were added instead of the solutions of the compounds of the invention (0 μg/mL). The percentage of motile cells in the different cellular suspensions was analyzed by CASA (Computer-Assisted Sperm Analysis) using an IVOS-IDENT (Hamilton-Thorn, Beverly, Mass.).

The cellular suspensions were processed for freezing using a standard freezing gradient as follows: cooling from room temperature to 4° C. in 30 min, from 4° C. to 0° C. in 3 min and immediately transferred to liquid nitrogen tanks. After 24 h in liquid nitrogen, the samples were thawed in a water bath at 37° C.

Results

The percentage of motile spermatozoa in the different samples obtained above was analyzed by CASA. Since vials corresponding to the different compounds were in different boxes inside the nitrogen tanks, a control was used for each group of compounds.

Results are shown in table 1. Values are the mean±SD from a total of 5 experiments per concentration.

TABLE 1

| | Percentage of motile spermatozoa | | | | | |
|---|---|---|---|---|---|---|
| | Concentration of compounds tested (approximate) | | | | | |
| Compounds tested | 0 μg/mL | 1 μg/mL | 10 μg/mL | 25 μg/mL | 50 μg/mL | 100 μg/mL |
| Example 4 | 47.6 ± 3.3 | 47.6 ± 3.7 | 49.8 ± 3.0 | 54.8 ± 5.2* | 59.4 ± 3.3** | 59.2 ± 2.8** |
| 4β-(S- | 48.6 ± 4.0 | 47.6 ± 3.0 | 52.0 ± 2.3 | 61.8 ± 2.6** | 69.8 ± 3.2** | 70.2 ± 2.8** |
| cysteinyl)epicatechin | | | | | | |
| (−)-epicatechin | 48.6 ± 3.5 | 46.8 ± 1.9 | 47.0 ± 2.2 | 47.6 ± 3.2 | 47.4 ± 2.6 | 46.8 ± 1.3 |

*p < 0.05;
**p < 0.001.

The results indicate that supplementation of the cryopreservation medium Cryoprotec with compounds of example 4 and 4β-(S-cysteinyl)epicatechin (described in the example of international application WO 03024951) at concentrations of 25, 50 and 100 μg/mL resulted in a significant increase in post-thaw motility recovery as compared to control (p<0.001). This increase in motility applies only to the high motility grades “a” and “b”. In addition, velocity parameters, including linear velocity (VSL) and lateral head displacement (AHL), which reflect high-quality motility, were significantly higher with these compounds. No significant differences in post-thaw motility recovery were found between (−)-epicatechin and control.

### Example 8

### Effect of Supplementation with 4-Thioderivative of Flavan-3-Ol on Postthaw Mouse Oocytes and Mouse Embryos

The protective effect of the additives on oocyte and embryo quality, following cryopreservation, is tested using mouse oocytes and mouse embryos (Embryotech Laboratories, Wilmington, Mass.). In brief, oocytes and embryos are frozen in medium containing different concentrations of the additive, and oocyte and embryo viability monitored by phase-contrast microscopy following thawing.

Particularly for embryos, viability and quality is ascertained by a correct embryo cell division rate during culture time, which should be: day 1, two-cell stage, day 2, four-cell stage; day 3, eight-cell stage; and day 4, blastocyst stage.

What is claimed is:

1. A medium for storing a biological sample in a refrigerated, frozen or vitrified state, comprising a balanced salt solution, a cryoprotectant and a 4-thioderivative of flavan-3-ol of formula (I) with cryoprotective effect: 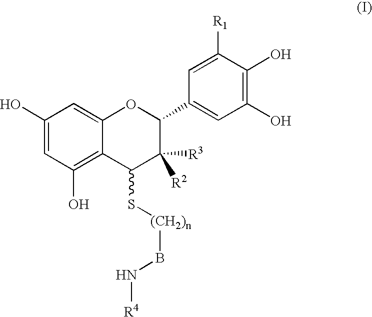
wherein:
R¹ and R² are H or OH;
R³ is different from R², and is H, OH or a group of formula: 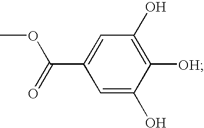
B=single bond or 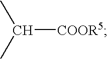
n=1-6;
R⁴=H, —C(O)—R⁶, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;
R⁵=H, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;
R⁶=linear or branched C₁-C₄ alkyl;
or a salt thereof, at a concentration sufficient to reduce cellular damage after storage in a refrigerated, frozen or vitrified state.

2. The medium according to claim 1, wherein said cryoprotectant is selected from the group consisting of DMSO, glycerol, propylene glycol, ethylene glycol and egg-yolk.

3. The medium according to claim 1, wherein said biological sample includes animal cells or human cells.

4. A medium according to claim 3, wherein said human cells or animal cells are selected from the group consisting of: sperm, oocyte, embryo and stem cells.

5. A medium according to claim 1, wherein when B of formula (I) is a single bond, then n is 2, and when B is 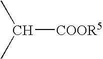
then n is 1.

6. A medium according to claim 1, wherein said 4-thioderivative of flavan-3-ol of formula (I) is selected from the group consisting of 4β-[S—(N-acetyl-O-methyl-cysteinyl)]epicatechin and 4β-(S-cysteinyl)epicatechin.

7. A method for reducing cellular damage to a biological sample, resulting from storage of said sample in a refrigerated, frozen or vitrified state, comprising the steps of:
a. combining a medium for storing a biological sample in a refrigerated, frozen or vitrified state, comprising a balanced salt solution and a 4-thioderivative of flavan-3-ol of formula (I) with cryoprotective effect: 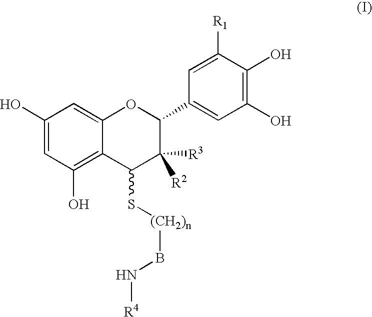
wherein:
R¹ and R² are H or OH; independent of each other, the same or different;
R³ is different from R², and is H, OH or a group of formula: 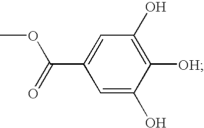
B=single bond or 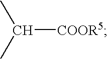
n=1-6;
R⁴=H, —C(O)—R⁶, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;
R⁵=H, linear or branched C₁-C₄ alkyl, or a natural amino acid selected from the group consisting of alanine, aspartic acid, glutamic acid, phenylalanine, glycine, histidine, isoleucine, lysine, leucine, methionine, asparagine, proline, glutamine, arginine, serine, threonine, valine, tryptophan, tyrosine;
R⁶=linear or branched C₁-C₄ alkyl;
or a salt thereof, at a concentration sufficient to reduce cellular damage after storage in a refrigerated, frozen or vitrified state,
and said biological sample, wherein said derivative of flavan-3-ol is in an amount effective to reduce said damage; and
b. storing said sample in a refrigerated, frozen or vitrified state.

8. The method according to claim 7, wherein said cryoprotectant is selected from the group consisting of DMSO, glycerol, propylene glycol, ethylene glycol and egg yolk.

9. The method according to claim 7, wherein said human cells or animal cells are selected from the group consisting of: sperm, oocyte, embryo and stem cells.

10. The method according to claim 7, wherein the amount of the derivative of flavan-3-ol is at a concentration of the derivatives of flavan-3-ol from 15 μg/mL to 500 μg/mL, measured in the stored sample.

11. The method according to claim 7, further comprising reducing cell damage after storage by at least 10% as compared to storage under substantially identical conditions in a substantially identical control storage medium without the derivatives of flavan-3-ol.

12. The method according to claim 7, wherein said biological samples are animal cells or human cells.

13. The method according to claim 7, wherein when B of formula (I) is a single bond, then n is 2, and when B is 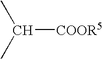
then n is 1.

14. The method according to claim 7, wherein said 4-thioderivative of flavan-3-ol of formula (I) is selected from the group consisting of 4β-[S—(N-acetyl-O-methyl-cysteinyl)]epicatechin and 4β-(S-cysteinyl)epicatechin.
